(19) United States
(12) Patent Application Publication
(10) Pub. No.: US 2012/0260339 A1
(43) Pub. Date: Oct. 11, 2012

(54) Imposter Prediction Using Historical Interaction Patterns

(75) Inventors: Kulvir Singh Bhogal, Pflugerville, TX (US); Lisa Seacat DeLuca, San Francisco, CA (US)

(73) Assignee: International Business Machines Corporation, Armonk, NY (US)

(21) Appl. No.: 13/080,884

(22) Filed: Apr. 6, 2011

(51) Int. Cl. G06F 21/00

(52) U.S. Cl. 726/23

(57) ABSTRACT

An approach is provided in which an electronic message is received from a source at a network interface that is accessible from the information handling system. A source address corresponding to the electronic message is identified, wherein the source address also corresponds to a legitimate source. Current usage patterns are extracted from the received electronic message and historical usage patterns are retrieved that correspond to the identified source address. The historical usage patterns being previously gathered from previous messages received from the legitimate source. The extracted current usage patterns and the retrieved historical usage patterns are compared. A user of the system is notified in response to the comparison revealing that the source is an imposter.

### BACKGROUND

The present invention relates to an approach that identifies possible imposters in a network environment. More particularly, the present invention relates to an approach that uses historical interaction patterns to identify a possible imposter in a network environment.

Modern communication increasingly takes the form of text messaging and email messaging. Obtaining entry to a user's text or email account, such as through an unattended personal computer, hacked password, or the like, allows an intruder, referred to as an imposter, to pose as the user. This ruse may cause severe consequences, such as disclosure of confidential or sensitive information to the imposter by another text or email user. In addition, the imposter may be able to post emails or text messages embarrassing or otherwise problematic to the user. The dangers of imposters in a network communication is often exacerbated when the true user does not learn of the imposter's violation for a period of time.

### BRIEF SUMMARY

According to one disclosed embodiment, an approach is provided in which an electronic message is received from a source at a network interface that is accessible from the information handling system. A source address corresponding to the electronic message is identified, wherein the source address also corresponds to a legitimate source. Current usage patterns are extracted from the received electronic message and historical usage patterns are retrieved that correspond to the identified source address. The historical usage patterns being previously gathered from previous messages received from the legitimate source. The extracted current usage patterns and the retrieved historical usage patterns are compared. A user of the system is notified in response to the comparison revealing that the source is an imposter.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE SEVERAL VIEWS OF THE DRAWINGS

The present invention may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a network diagram showing interactions between a user and a source which is either the legitimate account holder or an imposter of the legitimate account holder;

FIG. 4 is a flowchart showing steps taken to acquire historical usage pattern data while communicating with the source;

FIG. 5 is a flowchart showing the logic used in recognizing a possible imposter to an electronic communication;

FIG. 6 is a flowchart showing the logic used to process data found within a message that is received from the source; and

FIG. 7 is a flowchart showing a continuation of the logic used to process data found within a message that is received from the source.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

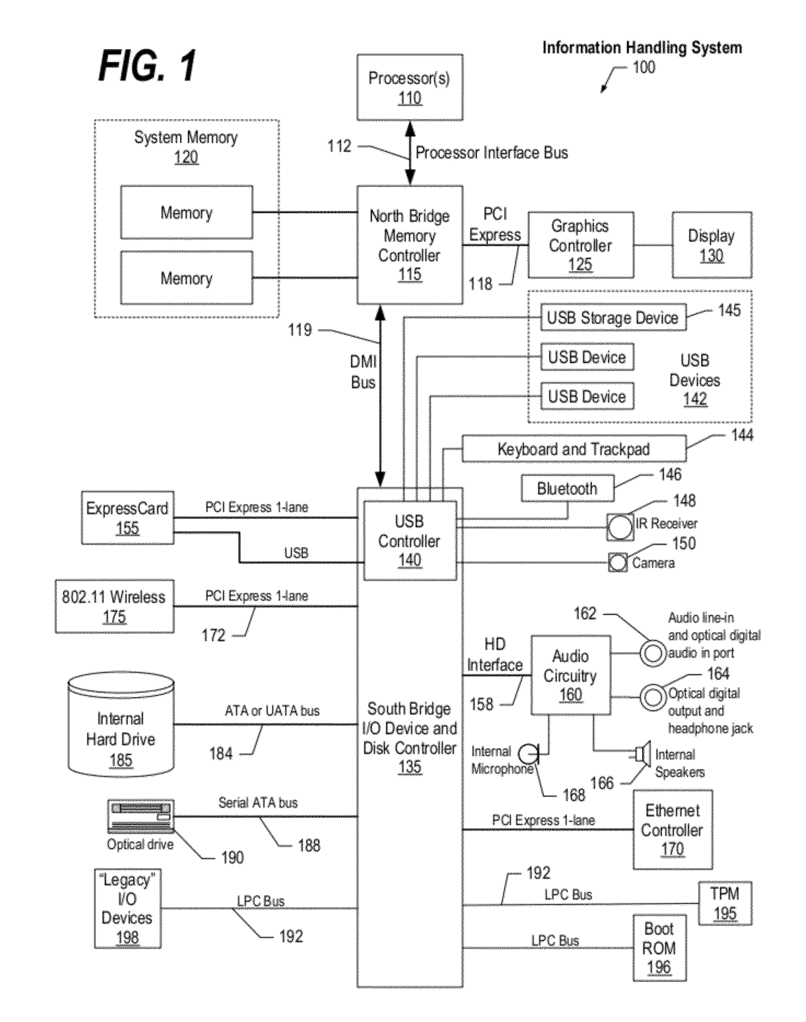

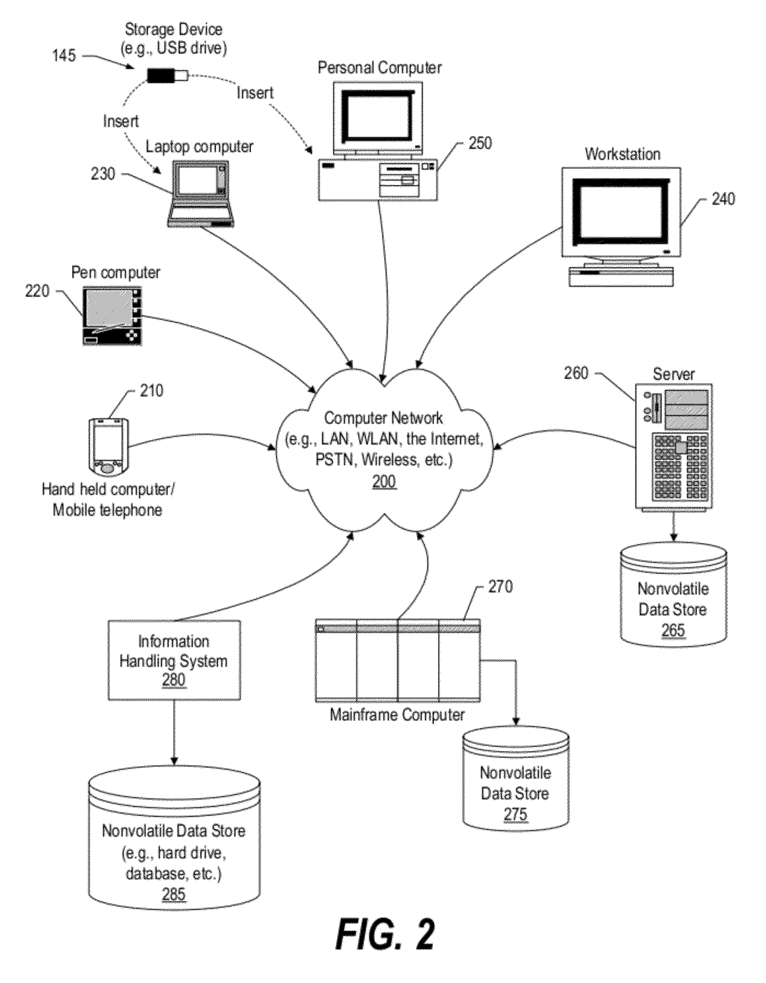

The following detailed description will generally follow the summary of the invention, as set forth above, further explaining and expanding the definitions of the various aspects and embodiments of the invention as necessary. To this end, this detailed description first sets forth a computing environment in FIG. 1 that is suitable to implement the software and/or hardware techniques associated with the invention. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

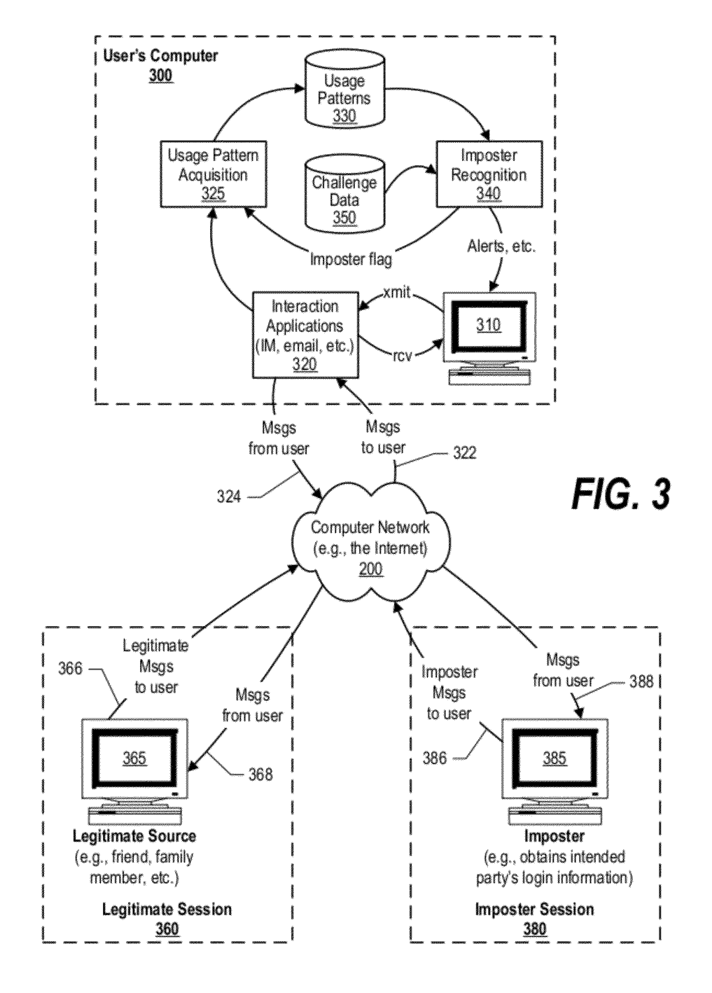

FIG. 3 is a network diagram showing interactions between a user 300 and a source which is either the legitimate account holder 365 or an imposter of the legitimate account holder 385 and their respective computers. User's information handling system 300 includes display screen 310 which is used to conduct electronic communications, such as text messaging sessions (chat, etc.) and email sessions with other users. These electronic communications utilize interaction software applications 320 which may include email systems instant messaging (IM) systems, and other text messaging systems. Interaction software applications 320 may be client-based application programs or may be network (e.g., Internet, etc.) based apps or programs that utilize programs, such as browser software, residing on the user's information handling system. While the information handling system shown is a traditional personal computer workstation, any of a variety of information handling systems, such as those shown in FIG. 2, may be used.

When an electronic message, such as an email message, text message, etc., is received from a source, usage pattern acquisition logic 325 is used to extract the current usage patterns from the electronic message and update usage patterns data store 325. This updating is performed while the source is not identified as being an imposter. Imposter recognition logic 340 compares the current usage patterns extracted from the current message with historical usage patterns previously stored in usage patterns data store 325. Usage patterns data store 325 can be a local data store included in the user's information handling system or can be a network-accessible data store that is accessed through a network, such as computer network 200 (e.g., the Internet, a LAN, etc.). Having the usage patterns data store be on a network-accessible data store would allow the user to access the data from a variety of devices, such as the user's work-based computer system, home-computer system, laptop computer system, mobile telephone, etc. If the imposter recognition logic senses that the source of the electronic message is an imposter, then an imposter flag is set and provided to usage pattern acquisition logic 325 to inhibit the acquisition logic from continuing to update the usage patterns data store. In addition, if the source of the electronic message is identified as being an imposter, than one or more alerts are provided to the user, such as a warning message displayed on display screen 310, an audible warning signal, or the like. Usage patterns can include several usage pattern types such as the acronyms commonly used by the legitimate source, a common response speed employed by the legitimate source (e.g., how fast the legitimate source typically responds to messages from the user, etc.), commonly misspelled words in messages received from the legitimate source, emoticons typically used by the legitimate source, common greeting phrases typically used by the legitimate source, common signoff phrases typically used by the legitimate source, and the common session times typically used by the legitimate source.

In one embodiment, challenge data is retrieved from challenge data store 350 in response to the imposter recognition logic sensing that the source is an imposter. Like the usage patterns data store described above, challenge data store 350 can also be a local data store included in the user's information handling system or can be a network-accessible data store that is accessed through a network, such as computer network 200 (e.g., the Internet, a LAN, etc.) to allow the user to access the challenge data from a variety of devices utilized by the user. The challenge data includes a challenge question and a correct answer to the challenge question with the challenge data pertaining to the legitimate source. For example, if the user knows that the legitimate source was born in Iowa City, Iowa, and few other people know this fact, then the challenge question might be “in what city and state were you born?” The source replies to the question and the reply is compared to the challenge answer to ascertain whether the source is the legitimate source or an imposter.

The user of information handling system 300 sends electronic messages 324 through network 200 to a source address. If the legitimate source is logged on and using another information handling system, the message is received as message 368 in legitimate session 360. The electronic message is displayed on display screen 365. The legitimate source sends legitimate message 366 to user 300 where it is received as received electronic message 322. Usage pattern acquisition logic, as described above, is used to extract current usage patterns from received electronic message 322 and update usage patterns data store 330. Because the source is the legitimate source, imposter recognition will clear the imposter flag and not recognize the source as being an imposter.

On the other hand, if an imposter gains access to the legitimate source's electronic communication system (e.g., by using the legitimate source's system while it is unattended, hacking the legitimate source's password, etc.), then imposter session 380 is established. Here, messages from user 300 are still received and displayed as incoming message 388 and displayed on imposter's display device 385. The imposter sends message 386 to the user (e.g., initiating an electronic communication session, replying to a message received from user 300, etc.) where it is received as message 322 at the user's information handling system. Usage pattern acquisition logic 325 extracts current usage patterns from electronic message 322 received from the source. Imposter recognition logic 340 then compares the extracted current usage patterns included in the electronic message with historical usage patterns retrieved from usage patterns data store 330 and reveals that the source of the message is an imposter. An alert is provided to the user warning the user that the source of the message is likely an imposter and the user can take appropriate steps, such as reporting the incident to the legitimate source through other means (e.g., telephone call, etc.), terminating the electronic communication session, etc. In addition, challenge data 350 can be utilized as previously described to challenge the source in order to better ascertain whether the source is the legitimate source or an imposter.

While FIG. 3 shows the processes being executed on the receiver's computer system, such processes could also be executed on another system, such as the legitimate source's system. In such an embodiment, the legitimate source's system would recognize whether the user currently using the system (e.g., the legitimate source or an imposter using the legitimate source's system) is an imposter based on the usage pattern acquisition logic and imposter recognition logic. When an imposter is identified, outgoing messages could be identified as being created by an imposter thus notifying the recipient. Moreover, the system could simply refrain from sending messages once the user of the system has been identified as being an imposter.

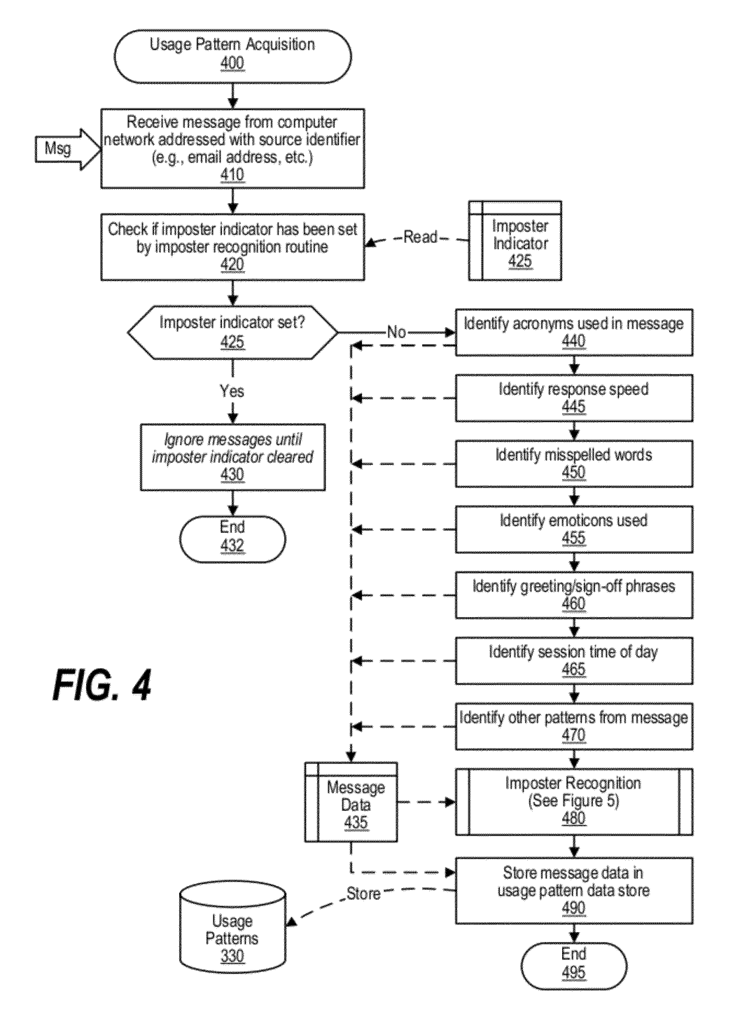

FIG. 4 is a flowchart showing steps taken to acquire historical usage pattern data while communicating with the source. The usage pattern acquisition commences at 400 whereupon, at step 410, an electronic message is received from a source at a network interface. In addition, a source address (e.g., email address, text message handle, etc.) is identified that corresponds to the received electronic message as well as to a legitimate source with whom the user regularly communicates. At step 420, an imposter indicator is checked (flag set in imposter indicator memory area 425) to see if the imposter recognition logic has identified this source as being an imposter.

A decision is made as to whether the imposter indicator is set (decision 425). If the imposter indicator is set (indicating that the imposter recognition logic has identified the source as being an imposter), then decision 430 branches to the “yes” branch whereupon, at step 430, this message and all further messages received from this source are ignored by the usage pattern acquisition logic and processing ends at 432.

On the other hand, if the imposter indicator is clear (not set indicating that the imposter recognition logic has not identified this source as being an imposter), then decision 425 branches to the “no” branch to extract current usage patterns from the received electronic message.

At step 440, acronyms used in the message are identified, extracted, and saved in message data memory area 435. At step 445, the response speed of the electronic message, if any, is identified and saved in memory data memory area 435. The response speed is a measure of how fast the source responded to a previous message from the user. At step 450, misspelled words included in the received electronic message are identified, extracted, and saved in memory data memory area 435. At step 455, emoticons included in the received electronic message are identified, extracted, and saved in memory data memory area 435. At step 460, greeting phrases and/or signoff phrases included in the received electronic message are identified, extracted, and saved in memory data memory area 435. At step 465, the time of day that the electronic message was received is identified and saved in memory data memory area 435. At step 470, other pattern data included in the received electronic message are identified, extracted, and saved in memory data memory area 435.

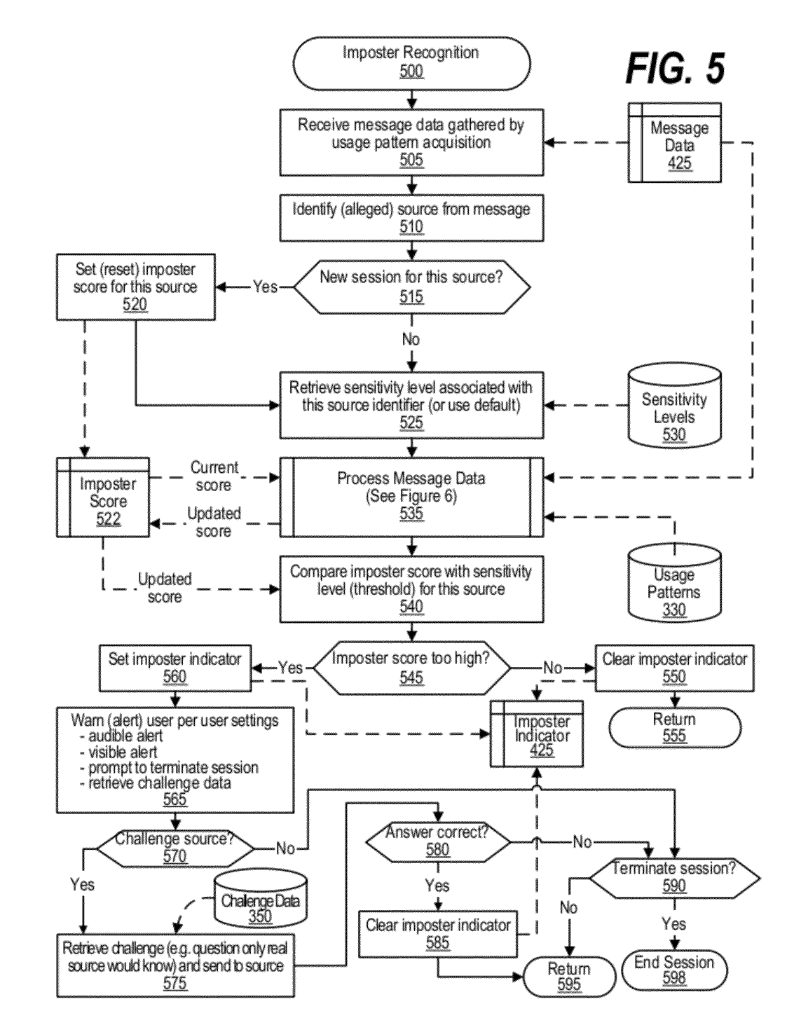

After current usage patterns have been extracted from the received electronic message, then message data memory area 435 is processed by imposter recognition at predefined process 480 (see FIG. 5 and corresponding text for processing details). At step 490, if the imposter recognition logic did not identify the source of the electronic message as being an imposter, then usage pattern data 330 is updated using the current usage patterns that were extracted from the received electronic message and stored in message data memory area 435. Usage pattern acquisition processing thereafter ends at 495.

FIG. 5 is a flowchart showing the logic used in recognizing a possible imposter to an electronic communication. Imposter recognition processing commences at 500 whereupon, at step 505, message data that was gathered by the pattern acquisition processing (see FIG. 4) is received from memory area 425. At step 510, the source is identified based on the sender's address included in the message. A decision is made as to whether this is a new or ongoing communication session with this sender address (decision 515). If this is a new session with this source, then decision 515 branches to the “yes” branch whereupon, at step 520, an imposter score value is reset (e.g., set to zero, etc.). If this is not a new session with this source (e.g., the user and this source have been communicating recently such as communicating text messages, emails, etc.), then decision 515 branches to the “no” branch bypassing step 520. At step 525 a sensitivity level is retrieved that is associated with the source identifier (address). In one embodiment, each source address can be assigned a different sensitivity level that is stored in nonvolatile data store 530. In this manner, legitimate sources that communicate more sensitive or confidential material can be assigned a sensitivity level that triggers an imposter alert more readily than a source that does not communicate such information.

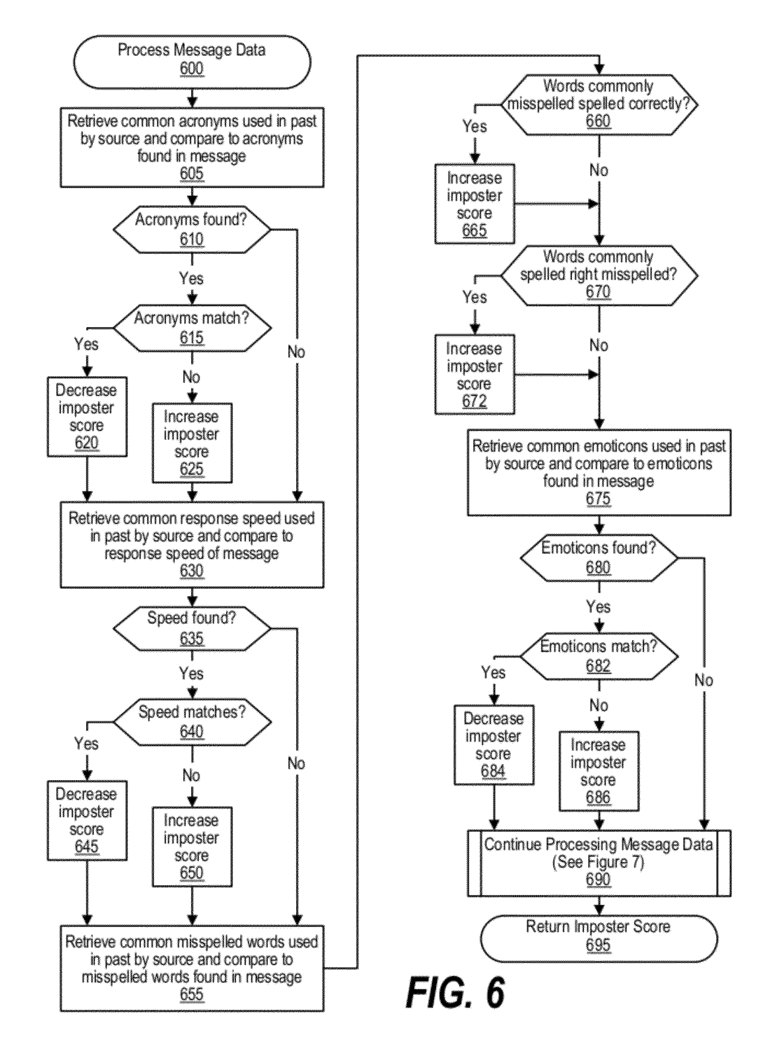

At predefined process 535, the message data extracted from the current electronic message is processed by reading message data 425 extracted by the pattern acquisition processing shown in FIG. 4 and also reading the current imposter score from memory area 522 (see FIG. 6 and corresponding text for details regarding the processing of the current electronic message). The processing of the message data results in predefined process 535 updating imposter score 522 based upon the analysis of the usage patterns included in the current electronic message.

At step 540, the imposter score that was updated by predefined process 535 is compared with the sensitivity level (threshold) assigned to this source address. A decision is made as to whether the imposter score exceeds the sensitivity level set for the source address (decision 545). If the imposter score is too high, then decision 545 branches to the “yes” branch whereupon, at step 560, imposter indicator (a flag) is set in memory area 425. This flag, while set, will prevent the pattern acquisition processing shown in FIG. 4 from updating the historical usage patterns corresponding to this source address with the usage patterns extracted from the current electronic message. At step 565, the user is warned that the source of the electronic communication might be an imposter. Warnings can be provided in any number of ways, such as an visual alert, and audible alert, a prompt to the user to terminate the communication session, and a retrieval of challenge data used to challenge the identity of the source. A decision is made as to whether to challenge the identify of the source (decision 570). If the user requests to challenge the identity of the source (or if the system does so automatically per settings), then decision 570 branches to the “yes” branch whereupon, at step 575, a challenge question is retrieved from nonvolatile data store 350 that corresponds with the legitimate source. The challenge question is ideally a question that would only be answerable by the legitimate source, such as the name of the source's favorite teacher, favorite pet, place of birth, etc. A reply is received from the source and a decision is made as to whether the source's reply (answer) correctly matches the answer stored in the challenge data store (decision 580). If the answer is correct, then decision 580 branches to the “yes” branch whereupon, at step 585, imposter indicator 425 is cleared and processing returns to the calling routine (see FIG. 4) at 595. Returning to decision 580, if the source's answer to the challenge question is incorrect, then decision 580 branches to the “no” branch whereupon a decision is made as to whether to terminate the electronic communication session with the source (decision 590). If the user does not wish to terminate the session, then decision 590 branches to the “no” branch whereupon processing returns to the calling routine (see FIG. 4) at 595. On the other hand, if the user wishes to terminate the session, then decision 590 branches to the “yes” branch whereupon processing and the electronic communication session end at 598.

Returning to decision 570, if the identity of the source is not being challenged (e.g., user does not wish to challenge, challenge data has not been gathered for this source, etc.), then decision 570 branches to the “no” branch which branches to the terminate session decision and actions as described above.

Finally, returning to decision 545, if the imposter score (as updated by the latest execution of processing of the message data shown in FIG. 6) is not too high, then decision 545 branches to the “no” branch whereupon, at step 550, the imposter indicator is cleared (e.g., set to zero, etc.) and processing returns to the calling routine at 555.

FIG. 6 is a flowchart showing the logic used to process data found within a message that is received from the source. Processing commences at 600 whereupon, at step 605, common acronyms (e.g., “lol,” “omg,” “asap,” etc.) that are commonly used by the legitimate source are retrieved as well as the acronyms found in the current electronic message. A decision is made as to whether any acronyms are found in the current electronic message or in the legitimate source's historical usage patterns (decision 610). If acronyms are found, then decision 610 branches to the “yes” branch whereupon a decision is made as to whether the acronyms used in the current electronic message match the acronyms historically used by this user (decision 615). If the acronyms match (same acronyms are being used), then decision 615 branches to the “yes” branch whereupon, at step 620 the current imposter score is decreased to indicate a lessened likelihood that the source is an imposter. However, if the acronyms do not match (different acronyms used in current message or acronyms typically used by the legitimate source are not being used and instead are being spelled out), then decision 615 branches to the “no” branch whereupon, at step 625, the imposter score is increased indicating an increased likelihood that the source is an imposter. Returning to decision 610, if no acronyms are found in either the current message or the historical usage pattern data, then decision 610 branches to the “no” branch bypassing steps 615 to 625.

At step 630, the common response speed of the legitimate source as recorded in the historical usage pattern data is retrieved and compared to the response speed of the current electronic message. The response speed is the amount of time the source takes to respond to a message from the user. If the source is sending the first message to establish an electronic communication session then a response speed will not be found for the current session, however subsequent messages in response to messages sent by the user will have a response speed. A decision is made as to whether a speed is found for the current session messages (decision 635). If a speed is found, then decision 635 branches to the “yes” branch whereupon a decision is made as to whether the response speed of the source roughly matches the historical response speed identified for the legitimate source. For example, if the legitimate source typically takes one minute to respond to messages but the current source is taking considerably longer, such as five minutes, to respond, then the speeds do not match. Likewise, if the current source responds much faster then the speeds also do not match. If the response speed of the message in the current session roughly matches the historical response speed for the legitimate user, then decision 640 branches to the “yes” branch whereupon, at step 645 the current imposter score is decreased to indicate a lessened likelihood that the source is an imposter. However, if the response speeds do not match (different response speeds found for the current message and the response typically found for the legitimate source), then decision 635 branches to the “no” branch whereupon, at step 650, the imposter score is increased indicating an increased likelihood that the source is an imposter. Returning to decision 635, if a response speed is not found (e.g., the received electronic message is the first message of the session, etc.), then decision 635 branches to the “no” branch bypassing steps 640 to 650.

At step 655 commonly misspelled words encountered in past communications with the legitimate source are compared with words found in the received electronic message. A decision is made as to whether words that the legitimate source typically misspells (e.g., the word “ridiculous,” is suddenly spelled correctly, etc.) are now spelled correctly in the received electronic message (decision 660). If words commonly misspelled by the legitimate source are now spelled correctly, then decision 660 branches to the “yes” branch whereupon, at step 665, the imposter score is increased indicating an increased likelihood that the source is an imposter. If words commonly misspelled by the legitimate source are not present or are not spelled correctly in the received electronic message, then decision 660 branches to the “no” branch bypassing step 665. In another embodiment, consideration can be taken and the imposter score adjusted if the words are misspelled but are not misspelled the same way that the legitimate source typically misspells them. A decision is then made as to whether words that the legitimate source typically spells correctly are misspelled in the received electronic message (decision 670). If misspelled words are found in the received electronic message that the historical usage pattern data reveals that the legitimate source typically spells correctly, then decision 670 branches to the “yes” branch whereupon, at step 672, the imposter score is increased indicating an increased likelihood that the source is an imposter. If words are not misspelled in the received electronic message, then decision 670 branches to the “no” branch bypassing step 672.

At step 675, common emoticons (e.g., smiley faces, frown faces, etc.) typically used by the legitimate source as recorded in the historical usage pattern data are retrieved and compared to emoticons found in the received electronic message. A decision is made as to whether any emoticons were found in either the historical data or in the current message (decision 680). If emoticons are found in either, then decision 680 branches to the “yes” branch whereupon a decision is made as to whether the emoticons typically used by the legitimate source are also the ones found in the received electronic message (decision 682). If the emoticons match, then decision 682 branches to the “yes” branch whereupon, at step 684 the current imposter score is decreased to indicate a lessened likelihood that the source is an imposter. However, if the emoticons do not match (different emoticons used in the current message or emoticons typically used by the legitimate source are not being used), then decision 682 branches to the “no” branch whereupon, at step 686, the imposter score is increased indicating an increased likelihood that the source is an imposter. Returning to decision 680, if no emoticons are found in either the current message or the historical usage pattern data, then decision 680 branches to the “no” branch bypassing steps 682 to 686.

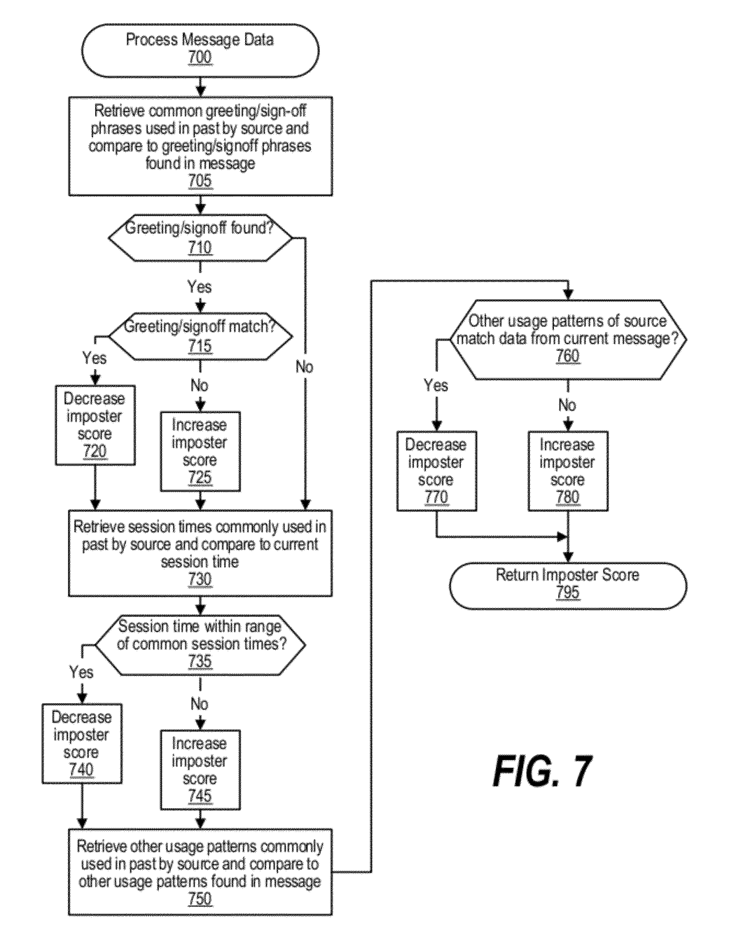

Processing of the received electronic message data continues at predefined process (see FIG. 7 and corresponding text for processing details). After the current message has been completely processed, then the updated imposter score is returned to the caller (see FIG. 5) at 695 and this imposter score is further used in the processing shown in FIG. 4 in order to inhibit collection of historical usage data while the source is identified as being an imposter.

FIG. 7 is a flowchart showing a continuation of the logic used to process data found within a message that is received from the source. Processing commences at 700 whereupon, at step 705, common greeting and/or sign-off phrases typically used by the legitimate source are compared with greeting/signoff phrases found in the current electronic message. A decision is made as to whether a greeting or signoff phrase is found in the current electronic message (decision 715). If a greeting or signoff phrase is found in the current electronic message and it matches the greeting/signoff phrase typically used by the legitimate user, then decision 715 branches to the “yes” branch whereupon, at step 720, the current imposter score is decreased to indicate a lessened likelihood that the source is an imposter. However, if a greeting/signoff phrase does not match the phrase typically used by the legitimate source (e.g., legitimate source greeting is typically “hey there” and the greeting found in the received message is “howdy,” legitimate source signoff phrase is typically “bye,” and the signoff phrase found in the received message is “see you later,” etc.), then decision 715 branches to the “no” branch whereupon, at step 725, the imposter score is increased indicating an increased likelihood that the source is an imposter. Returning to decision 710, if no greeting/signoff phrases are found in the current message, then decision 710 branches to the “no” branch bypassing steps 715 to 725.

At step 730, session times typically used by the legitimate source are retrieved and compared to the current session time (current time of day). A decision is made as to whether the current session time is within the range of common session times found for the legitimate user as recorded in the historical usage pattern data (decision 735). For example, if the legitimate user typically conducts electronic communication sessions with the user during standard business hours, then the standard business hours would be compared to the current time. If the session time of the received electronic message is within the range of common session times typically used by the legitimate user, then decision 735 branches to the “yes” branch whereupon, at step 740, the current imposter score is decreased to indicate a lessened likelihood that the source is an imposter. However, if the session times do not match (e.g., the legitimate user typically conducts electronic communication sessions with the user during standard business hours and the received electronic message is received late at night, etc.), then decision 735 branches to the “no” branch whereupon, at step 745, the imposter score is increased indicating an increased likelihood that the source is an imposter.

At step 750, other usage pattern data recorded for the legitimate source is retrieved and compared to other usage pattern data found in the current electronic message. A decision is made as to whether this other usage pattern data matches the legitimate sources' historical usage pattern data (decision 760). If this other usage pattern data matches, then decision 760 branches to the “yes” branch whereupon, at step 770, the current imposter score is decreased to indicate a lessened likelihood that the source is an imposter. However, if other usage pattern data does not match, then decision 760 branches to the “no” branch whereupon, at step 780, the imposter score is increased indicating an increased likelihood that the source is an imposter. Processing then returns to the calling routine (see FIG. 6) at 795 with the updated imposter score.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A method implemented by an information handling system comprising:
receiving, from a source, an electronic message at a network interface accessible from the information handling system;
identifying a source address corresponding to the electronic message, wherein the source address also corresponds to a legitimate source;
extracting one or more current usage patterns from the received electronic message;
retrieving, from a nonvolatile data store, one or more historical usage patterns corresponding to the identified source address, wherein the historical usage patterns were previously gathered from one or messages received from the legitimate source;
comparing the extracted current usage patterns to the retrieved historical usage patterns; and
notifying a user of the information handling system in response to the comparison revealing that the source is an imposter.

2. The method of claim 1 wherein the comparing further comprises:
retrieving an imposter sensitivity threshold value; and
generating an imposter score by comparing a plurality of current usage pattern types extracted from the received message with a plurality of historical usage pattern types retrieved from the data store, wherein the comparison reveals that the source is the imposter when the generated imposter score exceeds the imposter sensitivity threshold value.

3. The method of claim 2 wherein the current and historical usage pattern types are selected from the group consisting of one or more acronyms, a common response speed, one or more commonly misspelled words, one or more emoticons, one or more common greeting phrases, one or more common signoff phrases, and one or more common session times.

4. The method of claim 2 further comprising:
setting an imposter indicator in response to the comparison revealing that the source is the imposter;
clearing the imposter indicator in response to the comparison revealing that the source is the legitimate source;
collecting additional historical usage patterns from the received message while the imposter indicator is cleared; and
inhibiting further collection of historical usage patterns from the received message while the imposter indicator is set.

5. The method of claim 1 wherein the notifying further comprises:
retrieving a challenge question and a challenge answer from a second data store, wherein the challenge question and answer correspond to the legitimate source;
transmitting the challenge question to the source;
receiving a reply from the source; and
matching the reply received from the source with the challenge answer, wherein the source is deemed to be the imposter in response to the reply failing to match the challenge answer.

6. The method of claim 1 further comprising:
determining, based on the comparison, that the source is the legitimate source; and
adding the current usage patterns to the historical usage patterns in response to the determination.

7. The method of claim 1 wherein the notifying further comprises:
displaying a visual alert on a display device accessible from the information handling system, wherein the visual alert warns the user that the source is the imposter.

8. An information handling system comprising:
one or more processors;
a memory coupled to at least one of the processors;
a nonvolatile storage device accessible by at least one of the processors;
a network interface that connects the information handling system to a network;
a display screen coupled to at least one of the processors; and
a set of computer program instructions stored in the memory and executed by at least one of the processors in order to perform actions of:
receiving, from a source, an electronic message at the network interface;
identifying a source address corresponding to the electronic message, wherein the source address also corresponds to a legitimate source;
extracting one or more current usage patterns from the received electronic message;
retrieving, from the nonvolatile storage device, one or more historical usage patterns corresponding to the identified source address, wherein the historical usage patterns were previously gathered from one or messages received from the legitimate source;
comparing the extracted current usage patterns to the retrieved historical usage patterns; and
notifying a user of the information handling system in response to the comparison revealing that the source is an imposter.

9. The information handling system of claim 8 wherein the comparing further comprises additional actions of:
retrieving an imposter sensitivity threshold value from the memory; and
generating an imposter score by comparing a plurality of current usage pattern types extracted from the received message with a plurality of historical usage pattern types retrieved from the data store, wherein the comparison reveals that the source is the imposter when the generated imposter score exceeds the imposter sensitivity threshold value.

10. The information handling system of claim 9 wherein the current and historical usage pattern types are selected from the group consisting of one or more acronyms, a common response speed, one or more commonly misspelled words, one or more emoticons, one or more common greeting phrases, one or more common signoff phrases, and one or more common session times.

11. The information handling system of claim 9 wherein the processors perform additional actions comprising:
setting an imposter indicator in the memory in response to the comparison revealing that the source is the imposter;
clearing the imposter indicator in the memory in response to the comparison revealing that the source is the legitimate source;
collecting additional historical usage patterns from the received message while the imposter indicator is cleared; and
inhibiting further collection of historical usage patterns from the received message while the imposter indicator is set.

12. The information handling system of claim 8 wherein the notifying further comprises additional actions of:
retrieving a challenge question and a challenge answer from a second data store, wherein the challenge question and answer correspond to the legitimate source;
transmitting the challenge question to the source;
receiving a reply from the source; and
matching the reply received from the source with the challenge answer, wherein the source is deemed to be the imposter in response to the reply failing to match the challenge answer.

13. The information handling system of claim 9 wherein the processors perform additional actions comprising:
determining, based on the comparison, that the source is the legitimate source; and
adding the current usage patterns to the historical usage patterns in response to the determination.

14. A computer program product stored in a computer readable storage medium, comprising computer program code that, when executed by an information handling system, causes the information handling system to perform actions comprising:
receiving, from a source, an electronic message at a network interface accessible from the information handling system;
identifying a source address corresponding to the electronic message, wherein the source address also corresponds to a legitimate source;
extracting one or more current usage patterns from the received electronic message;
retrieving, from a nonvolatile data store, one or more historical usage patterns corresponding to the identified source address, wherein the historical usage patterns were previously gathered from one or messages received from the legitimate source;
comparing the extracted current usage patterns to the retrieved historical usage patterns; and
notifying a user of the information handling system in response to the comparison revealing that the source is an imposter.

15. The computer program product of claim 14 wherein the comparing further includes the information handling system performing additional actions comprising:
retrieving an imposter sensitivity threshold value; and
generating an imposter score by comparing a plurality of current usage pattern types extracted from the received message with a plurality of historical usage pattern types retrieved from the data store, wherein the comparison reveals that the source is the imposter when the generated imposter score exceeds the imposter sensitivity threshold value.

16. The computer program product of claim 15 wherein the current and historical usage pattern types are selected from the group consisting of one or more acronyms, a common response speed, one or more commonly misspelled words, one or more emoticons, one or more common greeting phrases, one or more common signoff phrases, and one or more common session times.

17. The computer program product of claim 15 wherein the information handling system performs further actions comprising:
setting an imposter indicator in response to the comparison revealing that the source is the imposter;
clearing the imposter indicator in response to the comparison revealing that the source is the legitimate source;
collecting additional historical usage patterns from the received message while the imposter indicator is cleared; and
inhibiting further collection of historical usage patterns from the received message while the imposter indicator is set.

18. The computer program product of claim 14 wherein the notifying further includes the information handling system performing additional actions comprising:
retrieving a challenge question and a challenge answer from a second data store, wherein the challenge question and answer correspond to the legitimate source;
transmitting the challenge question to the source;
receiving a reply from the source; and
matching the reply received from the source with the challenge answer, wherein the source is deemed to be the imposter in response to the reply failing to match the challenge answer.

19. The computer program product of claim 14 wherein the information handling system performs further actions comprising:
determining, based on the comparison, that the source is the legitimate source; and
adding the current usage patterns to the historical usage patterns in response to the determination.

20. The computer program product of claim 14 wherein the notifying further includes the information handling system performing additional actions comprising:
displaying a visual alert on a display device accessible from the information handling system, wherein the visual alert warns the user that the source is the imposter.
